(19) United States
(12) Patent Application Publication
(10) Pub. No.: US 2012/0010892 A1
(43) Pub. Date: Jan. 12, 2012

(54) SYSTEM AND METHOD FOR HANDLING COMPLEX CALCULATIONS IN SOCIAL SERVICES

(75) Inventors: Thomas Endres, Walldorf (DE); Banko Bantchev, Stuttgart (DE)

(73) Assignee: SAP AG, Walldorf (DE)

(21) Appl. No.: 12/833,471

(22) Filed: Jul. 9, 2010

(51) Int. Cl. G06Q 99/00

(52) U.S. Cl. 705/1.1

(57) ABSTRACT

Disclosed are embodiments that may provide a system, computer readable storage medium and a computer-implemented method for confirming and updating the type of benefits and an amount of service benefits to be provided to a recipient. The back end of the computer system may generate an entitlement document according to a services plan. A payment document containing data items indicating the type of benefits, the amount of services benefits to provide to the recipient, and a payment of the benefit may be generated according to the current entitlement document.

### REFERENCE TO RELATED APPLICATION

This Application incorporates by reference the entire contents of U.S. Non-Provisional Application Nos. ______ (Atty Docket Nos. 11884/511301, 11884/511501, 11884/511601, 11884/511701, 11884/511801) filed Jul. 9, 2010. This application is also related to U.S. patent application Ser. No. 12/333,766 filed on Dec. 12, 2008, the entire contents of which are incorporated herein by reference.

### FIELD

The disclosed subject matter relates to a system and method for handling complex calculations related to providing proper social services. In particular, the disclosed subject matter relates to the generation of structured electronic documents for properly processing payment and provision of service benefits.

### BACKGROUND

Modern enterprises such as governmental organizations and private businesses typically use computer systems to manage their operations. Enterprise management systems are computerized systems that define processes and protocols for various business operations. By using enterprise management systems, public and private organizations can define processes that are to be undertaken during performance of the organization's operations which can be applied uniformly among a large set of employees.

In the case of social services providers, an enterprise management system can be used to manage provision of requested social services. In order to insure accurate distribution of social services benefits, the enterprise business systems may update the status of beneficiaries, the status of applicable laws and regulations including tax changes, status changes resulting from legislation and other aspects of the provided social services that may be subject to change.

When these updates are implemented, the effects of the updates may be to the benefits received by a single person or an entire population of people receiving social services. It becomes very complicated and time consuming to not only identify those affected by the updates, but also perform individual changes to a person's or group of persons social services benefits. Both of these operations may be time consuming and may take a significant amount of time to process.

In addition, errors in the amounts of social service benefits provided may result in either a significant amount of either overpayment or underpayment of benefits which wastes resources and may adversely affect social service providers and recipients. Accordingly, a need exists for a method and system for updating and confirming entitlement to social services, and for proper management of payments provided to the recipients.

### BRIEF DESCRIPTION OF THE DRAWINGS

FIG. 1 illustrates an exemplary document generation process according to a disclosed embodiment.

FIG. 2 illustrates a detailed example of the exemplary document process illustrated in FIG. 1.

FIG. 3 illustrates an exemplary modification of documents according to a disclosed embodiment.

FIG. 4 illustrates an exemplary process flow according to a disclosed embodiment.

FIG. 5 illustrates an exemplary process flow for calculating a retroactive item according to a disclosed embodiment.

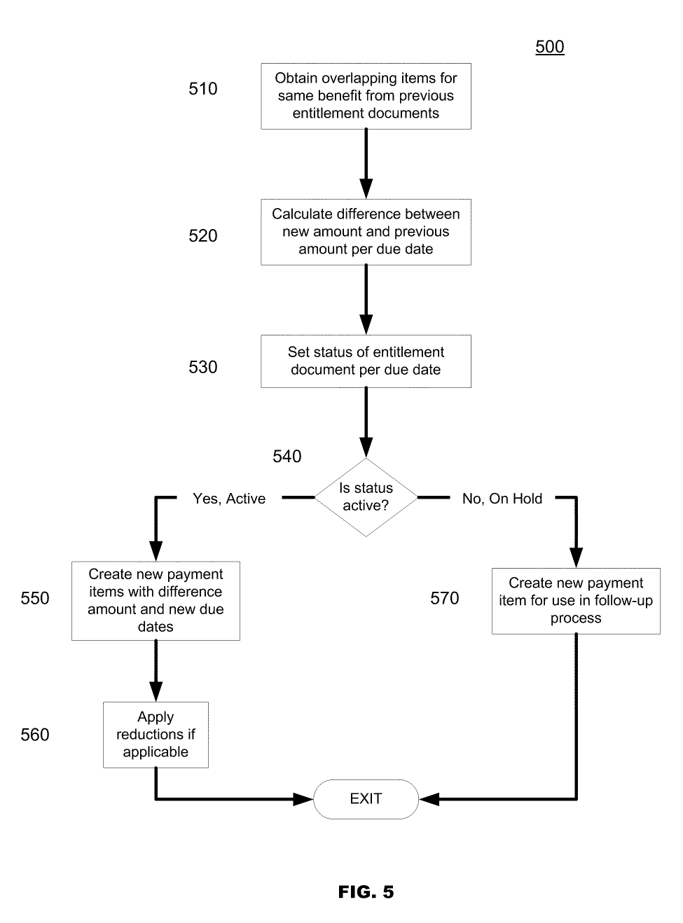

FIG. 6 illustrates an exemplary process flow for calculating a future item according to a disclosed embodiment.

FIG. 7 illustrates an exemplary process flow for performing a net calculation according to a disclosed embodiment.

FIG. 8 illustrates an exemplary computer system for implementing a social services system according to a disclosed embodiment.

### DETAILED DESCRIPTION

Applicants have developed a system, a machine-readable storage medium, and method for handling complex calculations in the management of social services benefits. The disclosed embodiments provide a computer-implemented method for confirming and updating the type of benefits and an amount of social service benefits provided to a recipient. The method may include obtaining, at a back end of a computer system, data of a social services plan generated at a front end of the computer system. The social services plan may include data items indicating the type of benefits to be provided, dates for providing the benefits, and determination dates of the benefits. The front end of the computer system may generate according to the data of the social services plan, a current entitlement document that may contain current data items indicating the type of benefits to be provided, dates on which the benefits are due to be provided, and the amount of benefits the recipient is entitled. A gross payment document may be generated that contains data items. The data items may include data items indicating the type of benefits, the amount of social services benefits to provide to the recipient, and the frequency of payment of the benefit. The generated gross payment document data may trigger payment to the recipients or be used, for example, to update payments to the benefit recipients.

Social services are commonly provided by governmental agencies in cooperation with service providing partners, such as private food pantries, soup kitchens, government-run health facilities, or private healthcare providers. The provision of social services, or simply benefits, is typically accomplished according to a social services plan developed for the requestor. For example, a requestor may be temporarily out of work and may need food stamps to feed his children and medical coverage for himself and his family, while another requestor may be homeless and need access to a shelter, clothing and food. Due to their circumstances, these two requestors may have differing status and, as a result, may require different plans for coordinating the benefits provided to each. The government social services office or department may formulate different social services plans for each of the requestors. Once the social services plan is developed (and approved), it may be implemented. However, other non-governmental agencies or private organizations that provide services, such as providing scheduled payments by a bank, or pension payments or the like, may benefit from the disclosed embodiments. For sake of clarity, the disclosed embodiments will be described with reference to the provision of social services.

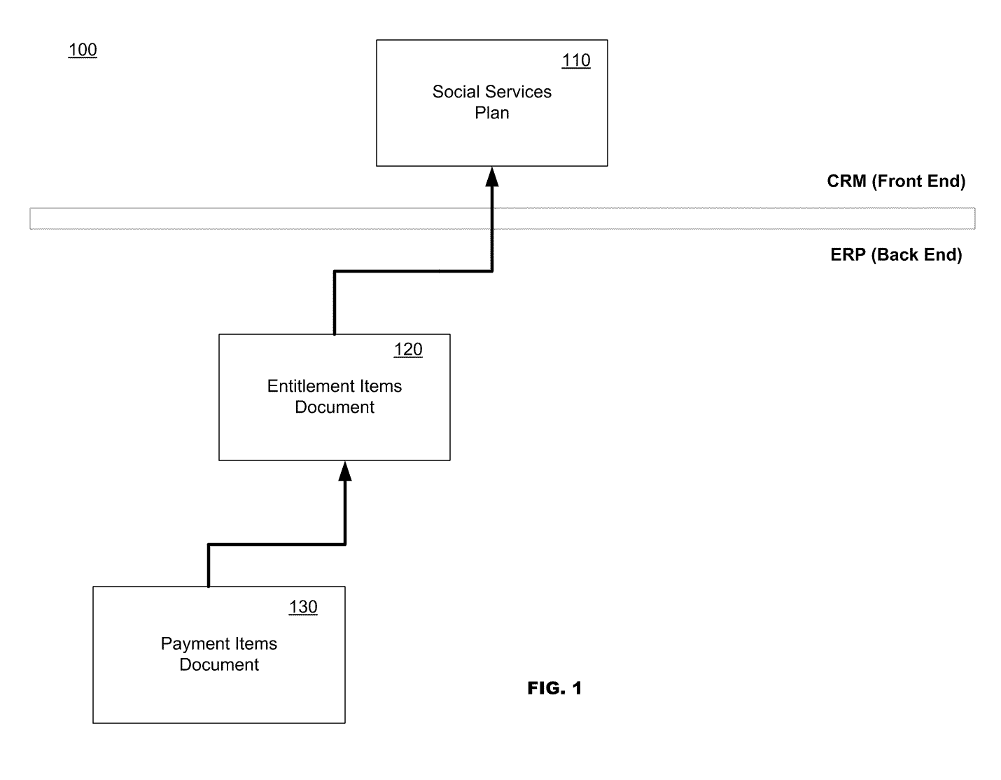

In order to manage the provision of the social services benefits, a number of electronic documents may be generated. The document generation flow after approval of a social services plan for a recipient will be described in more detail with reference to FIG. 1. The exemplary document generation process illustrated in FIG. 1 is shown as being implemented on an exemplary computer system implemented with a front end and a back end, that can be implemented by a customer relationship management (CRM) application and an enterprise resource planning (ERP) system, respectively. Of course, this separation is exemplary, and one of skill in the art may implement the disclosed embodiments using other systems, and computer system configurations. In an exemplary document generation process, for example, a social services requestor/recipient using a client computer to interface with a front end of a computer system may fill out an application requesting social service benefits, and begin the document generation process 100. Upon approval of the social services benefit request, a social services plan 110 may be created at the front end of the computer system. The social services plan 110 may be populated with data items. The data items in the social services plan 110 may include data such as, a unique identifier of the social services plan 110 or the requestor/recipient 105, the benefits to be provided (i.e., benefit scenario), identity of business partners that will be implementing the benefits scenario, the decision period (i.e., how long the benefits will last at the present levels), and header information. The unique identifier may be a case assignment number or some other indicator of the recipient related to the social services plan 110. The front end system such as a CRM system may release the data of the social services plan. The data is transferred from CRM to ERP using a remote function call. The remote function call may include, for example, the identify of the new social services plan 110 and the identity of programs for which the recipient has been approved. Upon release in the CRM, the back end ERP system may use the data of the social services plan 110 to generate entitlement data items of the entitlement items document comprising monetary amounts for the services indicated in the social services plan.

The generated entitlement items document 120 may store the calculated monetary amounts of benefits for each of the social services identified in the social services plan 110 for the recipient. Entitlement data items in the entitlement items document 120 in addition to monetary amounts may also include data replicated from the social services plan 110 data items in the front end CRM application. The replicated data in the entitlement items document 120 may include some or all of the data included in the social services plan 110. In addition, entitlement data items may be generated that include additional data, for example, a lifetime maximum benefit amount, related to entitlements for specific services.

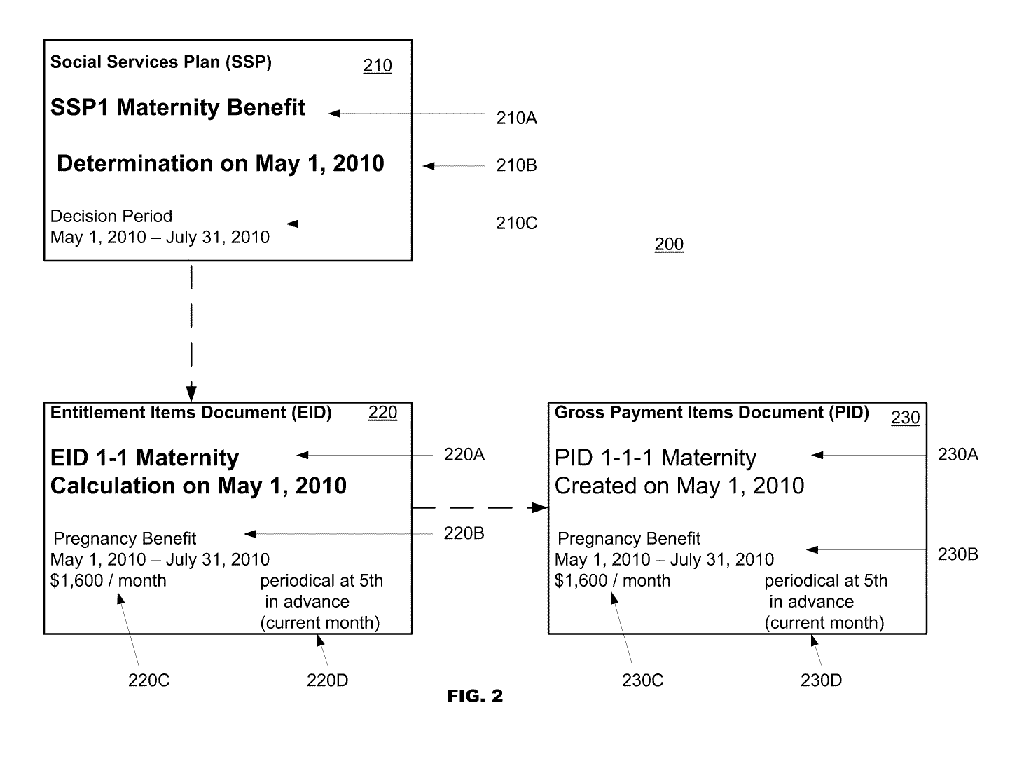

Specific service entitlements may include monetary values, for example, for a housing allowance, a food stamps allowance, a medical services allowance, a clothing allowances, and other monetary social service benefits allowances. The monetary value of specific service entitlements may be established according to current customizable rule sets as applied to the particular requestor's social services plan. Once the entitlement data items in the entitlement items document 120 have been populated, the entitlement items document 120 may be released. Upon release of the entitlement items document, the back end ERP system may access the front end CRM system using, for example, a remote function call to obtain data to generate the entitlement items document 120. The back end ERP system may calculate actual monetary payments that are due to the recipient. The retrieved data may be incorporated into a gross payment items document 130 by the back end ERP system. In addition, results from the calculations of the actual monetary payments performed by back end ERP system may be stored as data items in the gross payment items document 130. The entitled monetary values stored in the gross payment items document may represent the actual amounts that may be paid to the recipient (e.g., prior to taxes, deductions and other factors that may reduce the payment). The content of each of the social services plan 110, the entitlement items document 120 and the gross payment items document 130 will be explained in more detail with reference to FIG. 2.

FIG. 2 illustrates a detailed example of the exemplary document process illustrated in FIG. 1. For example, in the document process 200 of FIG. 2, a social services plan 210 may have been generated for a requestor who may be eligible of social benefits. The social services plan 210 may include data items 210A, 210B and 210C. Data item 210A may indicate the specific benefit for which the recipient is entitled. Data item 210B may indicate the date on which it was determined the recipient will be eligible for the specified benefit. Data item 210C may indicate the duration of the benefit. In the illustrated example, the benefit, data item 210A, for which the recipient is eligible is a maternity benefit. The determination date, data item 210B, is May 1, 2010. The duration of the benefit, or decision period, may also be stored as data item 210C, which in this case is from May 1, 2010 to Jul. 31, 2010. Of course, the specific benefits and the duration of the benefit may vary according to a customizable rule set for a particular jurisdiction.

Using the data items 210A, 210B and 210C, the back end ERP system may generate an entitlement items document (EID) 220. The back end system may calculate the monetary amounts to which the recipient is entitled according to the data items 210A, 210B and 210C of social services plan 210. The back end system may use a customized rule set related to the recipient's jurisdiction to calculate the monetary benefit amounts to which the recipient is entitled. The customized rule set may include monetary limits, limits on the duration of the benefit, weighting factors that may include number of dependents, household income levels, and the like. The EID 220 may include, for example, the data item 220A which may indicate the calculated monetary benefit entitlement for the identified benefit from the SSP data item 210A. In the illustrated example, data item 220A indicates the maternity calculation that is performed for the May 1, 2010 determination date. The EID data item 220B may indicate the specific benefit that is to be provided, which in the illustrated example is a pregnancy benefit, and the duration of the benefit, which in the illustrated example is May 1, 2010-Jul. 31, 2010, or 2 months. The EID 220 may include a data item 220C that is representative of the specific amount that a recipient is entitled. In the illustrated example, data item 220C has been calculated as $1600 per month ($1,600/month); however, the calculated benefit may have been shown as a daily or weekly benefit. The EID 220 may also include a data item indicating the period for payment of the entitled monetary amount. For example, as shown in FIG. 2, the entitled period for payment data item 220D is shown as a periodical payment to be paid on the 5^{th} of the month in advance (current month), which means the payment is to be made periodically on the 5^{th} day of the month and that the benefit is to be paid the month in advance of the entitled month.

Using the calculated amounts and entitled period of payment from the EID 220, the back end system may use the data items from the EID 220 to generate a gross payment item document (PID) 230. Data items from the SSP 210 as well as the EID 220 may be replicated in the PID 230. For example, the benefit to be paid data item 230A may be based on the data items 210A and 220A from the SSP 210 and EID 220, respectively. The specific benefit that is to be paid data item 230B tracks the specific benefit data item 220B from the EID 220. Similarly, the benefit payment data item 230C and payment period data item 230D of the PID 230 tracks to data items 220C and 220D. The PID 230 or select data items from the PID 230 may trigger a payment. For example, the PID 230 may be provided to an accounting computer application executing on a server or other device that may generate a payment to the recipient for the indicated benefits, such as the illustrated pregnancy benefit.

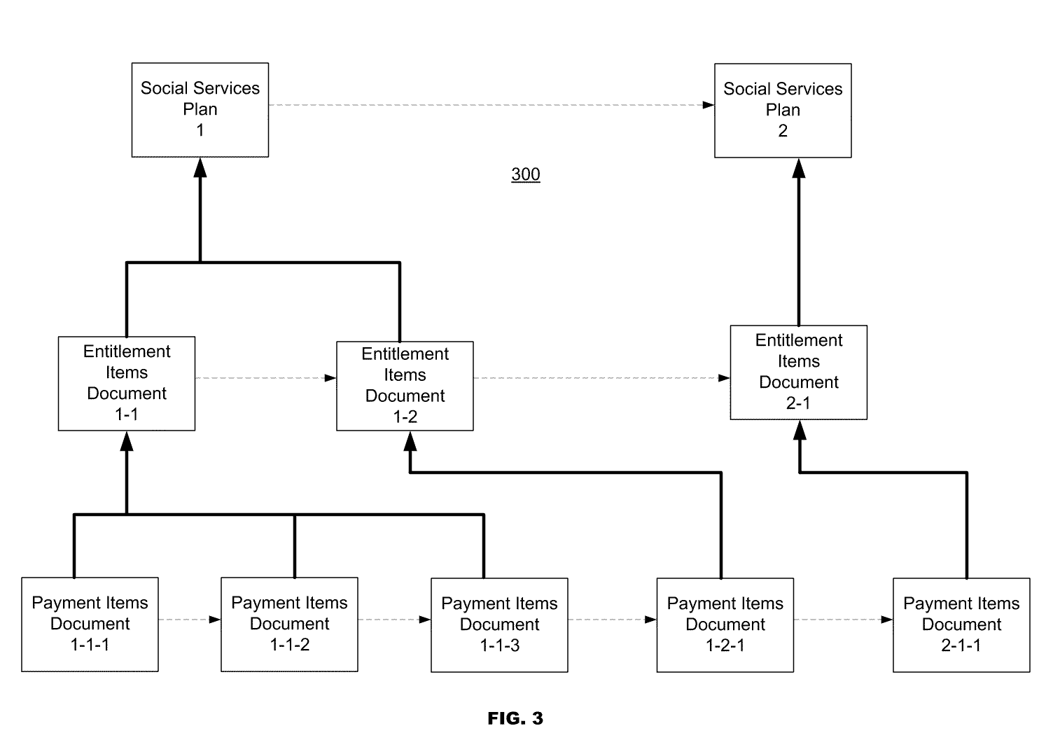

FIG. 3 illustrates an exemplary modification of documents according to a disclosed embodiment. As conditions related to the recipient and the provision of social benefits in jurisdictions related to the recipient may change, the SSP, EID and PID documents may need to be modified. In the process 300, a social services plan 1 (SSP1) may be generated for a recipient. The social services plan 1 (SSP1) may be used to initially generate an entitlement items document (EID) 1-1. As explained above, the data items in the SSP may be used by a back end system to calculate a monetary amount that the recipient may be entitled to receive. The back end system may use the entitled monetary values from the EID 1-1 to generate a gross payment items document representing the actual amounts that may be paid to the recipient prior to taxes, deductions and other factors that may reduce the payment. Multiple PIDs may be generated from a single EID. In the illustrated example, PIDs 1-1-2 and 1-1-3 may also be generated based on other entitled amounts, determined decision period, both or some other factor such as a one-time benefit payment. The PIDs 1-1-2 and 1-1-3 may be payments for different types of social services. The new PID (e.g., PID 1-1-2) may also provide a one time payment for a benefit or to address an underpayment of a particular benefit. For example, PID 1-1-2 may be a payment for a housing allowance, while PID 1-1-3 may be a payment for child care services. As each new PID is generated, it may include the data items from the previous PID. For example, PID 1-1-2 may incorporate all of the data items of PID 1-1-1 in addition to any new data items generated from the EID 1-1-1. Similarly, PID 1-1-3 may incorporate all of the data items from PIDs 1-1-1 and 1-1-2.

Continuing with the example, EID 1-2 may be generated due to a change in the customized rule set that causes entitlement amounts to be calculated differently from when EID 1-1 was generated. For example, the jurisdiction in which the recipient lives may increase monetary entitlement amounts for the number of children that are dependent on the recipient, or due to the age of the recipient. From the new EID 1-2, a new PID 1-2-1 may be generated to pay out any of the amounts due under the new EID 1-2.

In situations where the conditions of the recipient changes, such as becoming employed or unemployed, loss of home, or the birth of a child, the social services plan 1 (SSP1) may be updated and changed. Due to the change, a new social services plan, social services plan 2 (SSP2), may be generated. The new SSP 2 may contain additional or less social services, or an altered scheduled provision of a social service for the recipient. Since the SSP 2 contains updated information, a new entitlement items document, EID 2-1, containing the calculated monetary amounts of social services the recipient is entitled to receive may be generated. In response to the generated EID 2-1, a new payment items document (PID) 2-1-1 containing the calculated amounts that a recipient will receive as payment may be generated.

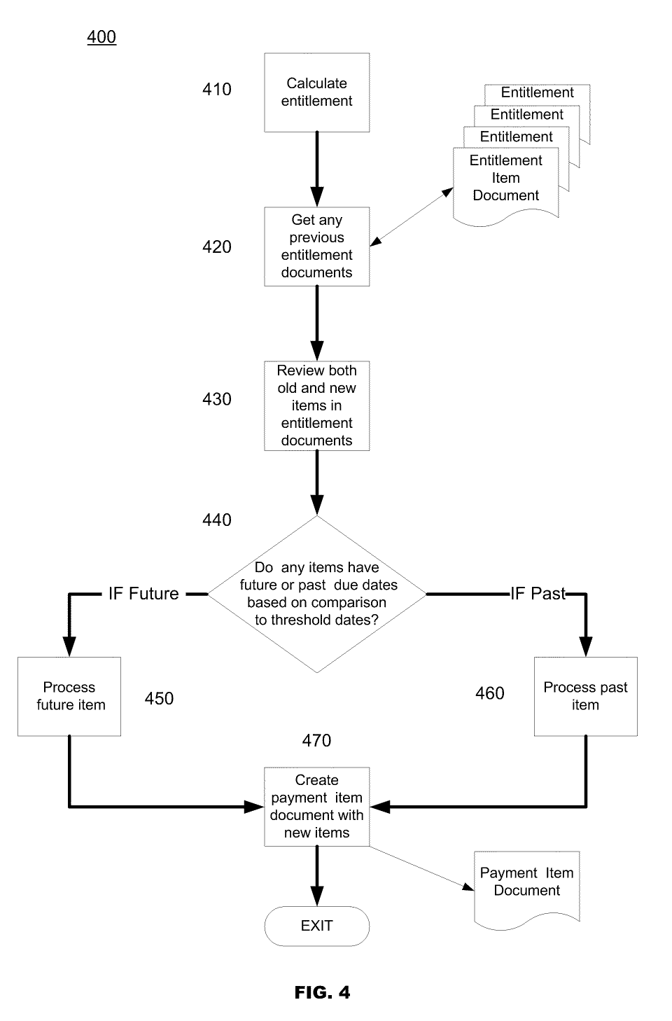

FIG. 4 illustrates an exemplary process flow according to a disclosed embodiment. In the exemplary process 400 occurring, for example, at a back end system the recipient's entitlement may be calculated at step 410. The calculated entitlement may be stored, and at step 420, previous entitlement documents with the gross entitlements may be retrieved from data storage. The back end system may review, at step 430, both the old and newly calculated data items within the entitlement documents. During the review, a decision at step 440 may be made whether any data items have future or past due dates based on a comparison to a threshold date. For example, a future due date may mean that the payment for social services can be executed on time. Meanwhile, a past due date may mean that the payment will not get to the recipient on time and must be handled otherwise. Data items may either be one or the other. If the due date is determined to be a future due date, the item may be processed as a future item at step 450. If the due date is determined to be a past due date, the item is processed as a future item at step 460. After the data item is processed as either a future item or past item, the process 400 may proceed to step 470 at which a current payment item document is generated with the new items. The newly created, current payment item document may be stored in memory.

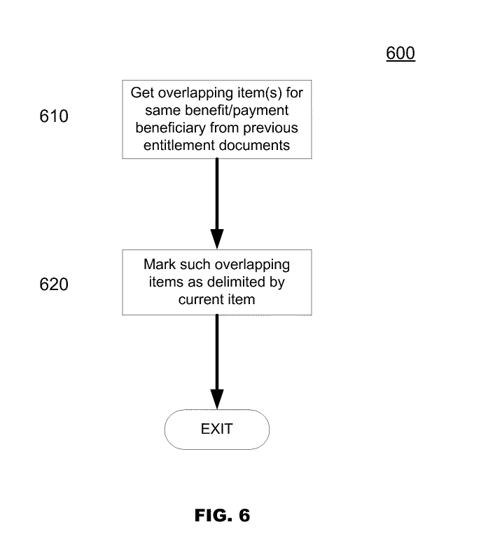

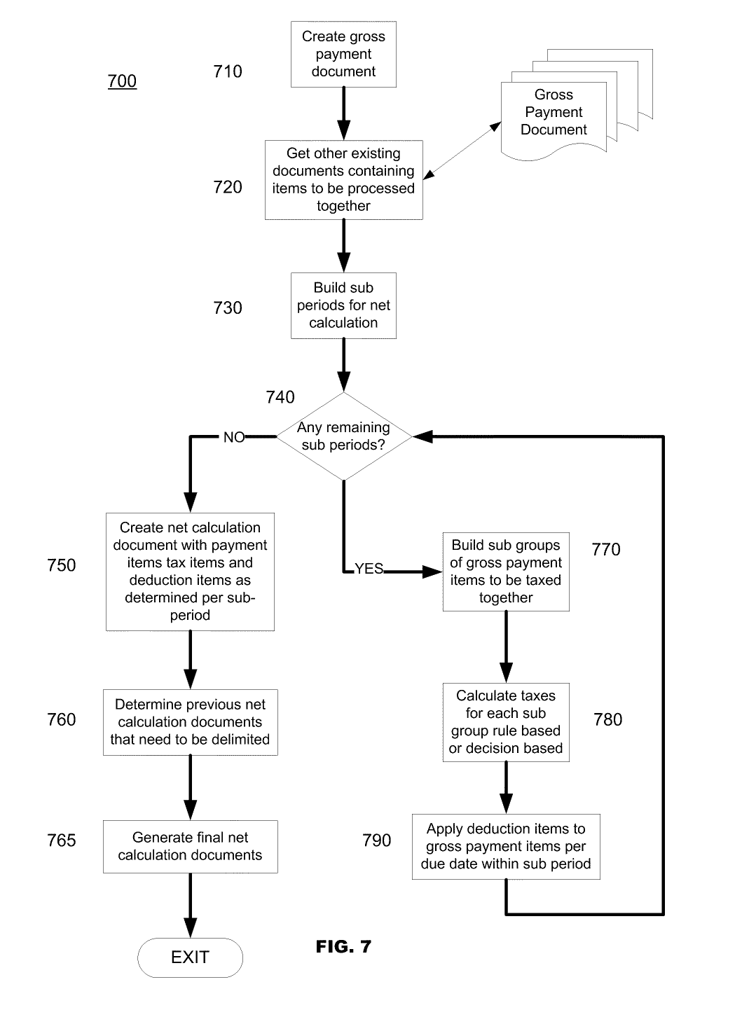

The processing of either a future item or a past item may affect the payment to the recipient. Each of the payment processes for the future item payment and the past item payment may be different, and will be explained in more detail with reference to FIGS. 6 and 7. FIG. 6 illustrates an exemplary process flow for calculating a past item according to a disclosed embodiment. If the item is determined to be a past item at step 440, the process 500 may be implemented. At step 510, any data items having overlapping due dates for the same benefits may be retrieved from any previous entitlement items documents. Once the data items are retrieved from the previous entitlement items documents, an entitlement amount difference may be calculated, at step 520, between the new entitlement amount and previous entitlement amounts per the due date. At step 530, the status of the entitlement item document may be set according to the due date. A determination may be made at step 540 of whether the status of the entitlement item document is active or not. If the status of the entitlement item document is determined to be active, the process 500 proceeds to step 550, otherwise, it proceeds to step 570.

If the status is active, process at step 550 creates new payment items with the difference amounts and with new due dates. Any deductions to the entitlement, if applicable, may be applied at step 560, and the process exits the process 500. It may exit back to process 400 for execution of step 470.

Alternatively, if the item is determined to be a future item at step 440 of process 400, the process 600 may be implemented. FIG. 7 illustrates an exemplary process flow for calculating a future item according to a disclosed embodiment. The future item processing 600 begins at step 610 by retrieving any data items from any previous entitlement items documents having overlapping due dates for the same benefits. The overlapping data items may be marked at step 620 as delimited by the current item. Delimiting meaning that the benefit may be reduced by any previous payments. The benefit reduction occurring in a further process. The processing of the future item finishes, and may return to process 400.

The previously described payment items document contained gross payments to the recipients. The gross payments may be subject to taxes, deductions, other reductions or additions. The net final payments to the recipient may be calculated which may incorporate any taxes, deductions (delimits), increases and the like. This calculation may be performed at the back end system. FIG. 7 illustrates an exemplary process flow for performing a net calculation according to a disclosed embodiment.

At step 710, the gross payment item document may be created from an entitlement items document. Other gross payment item documents in step 720 may be retrieved so that any data items that are contained in those PIDs may be processed together with the present data items. This provides a method for determining whether too much (overpayment) or too little (underpayment) was paid out to the recipient. Previous PIDS are compared with the current ones for overlapping time periods. The system may generate sub-periods based on the determination dates from the SSP, the calculation dates from the EID and the creation date from the PIDs. For example, if for several dues dates a payment amount does not change (recurring payment), then the due dates can be combined into a sub-period. If at a point in time the amount changes, a new sub-period may be created. At step 740, it is determined whether any sub periods remain. If YES, sub periods do remain, the process 700 proceeds from step 740 to step 770 in which sub groups may be built comprising gross payment items that are to be taxed together. After the sub periods are built, the taxes may be calculated at step 780 based on either a sub group rule or based on a decision such as approval of a particular social service plan, for each built sub group. Once the taxes are calculated, deduction items may be applied at step 890 to the gross payment items per due dates within the sub period.

Alternatively, if the determination at step 740 is NO, there are no remaining sub periods, the process 700 proceeds to step 750. At step 750, a net calculation document may be created with payment item tax items and deduction items as determined for each sub period. The process may determine at step 760 whether any previous net calculation documents may need to be delimited. Using this information, a final net calculation document may be generated at step 765, thereby finalizing the actions of steps 750 and 760, and stored.

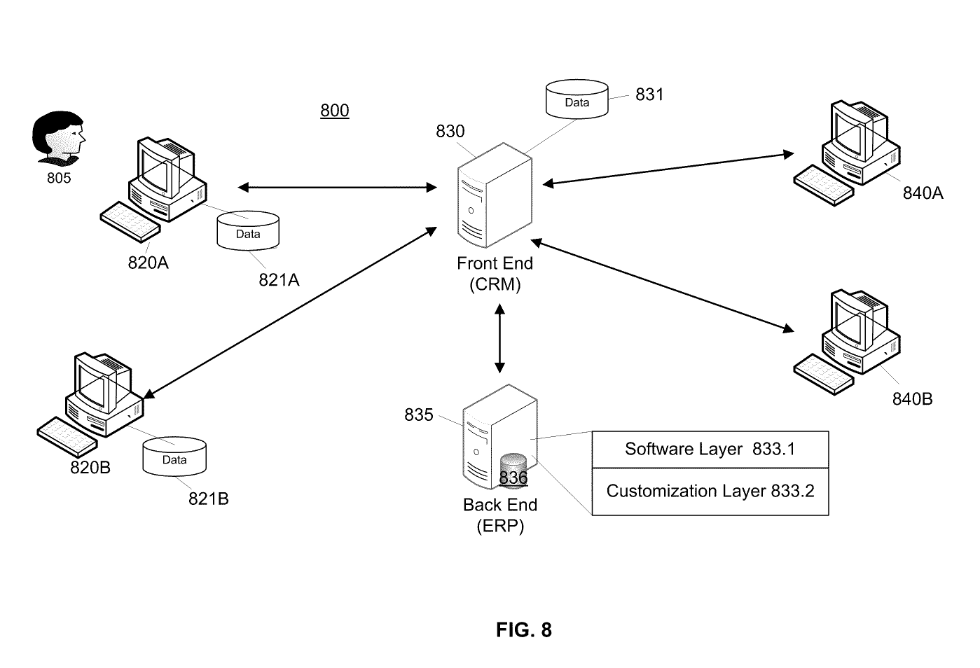

FIG. 8 illustrates an exemplary computer system for implementing a social services system. The system 800 may comprise a plurality of clients 820A and 820B, a front end server 830, a back end server 835, and a plurality of service partners 840A and 840B. Each client 820A-B may include a client computer 821A-B or, simply, be a terminal connected to the front end server 830 to allow a requestor/recipient 805 to interface with the system 800. The requestor/recipient 805 may provide information via a graphical user interface to the client 820A identifying the benefit(s), e.g., food stamps, meal tickets, healthcare, transportation, shelter and the like, the requestor/recipient 805 wishes to receive. Using software embodied on a storage device within any of computer 820A, a data storage 821A, a data storage 831, or on server 830, a social service plan may be generated based on electronic forms provided to the client 820A from either computer 821A or front end server 830. However, each of clients 820A-B may be located in different jurisdictions, such as a different country, or, if in a different state, or county within a state, all of which may have different eligibility requirements for obtaining services and different approval rules for granting approval of the requested services. Therefore, the front end server 830 may provide a customized rule set retrieved from a data storage to generate the correct social services plan for the requester. The front end server 830 may execute, for example, a customer relationship management (CRM) computer application via the clients 820A or 820B to facilitate the requesting and approving process for the requestor/recipient 805. The front end server 830 may also communicate with a back end server 835 that may also, or instead of front end server 830, maintain the customized rule sets applicable to the different evaluations performed in the process. For example, the customized rule set may be retrieved by the front end server 830 from a software layer 833.1 and/or a customization layer 833.2 of the back end server 835. Of course, the customized rule sets may be distributed between the front end server 830 and the back end server 835.

The front end server 830 or the back end server 835 may include a software layer 833.1 that implements, for example, a social services computer application and a customization layer 833.2 that implements customized rule sets for each jurisdiction. An exemplary software architecture of the software layer 833.1 may include a basic application framework that facilitates the creation of a social services plan and computer executable instructions for generation of the previously-explained entitlement item documents, the payment item documents and calculation of the net payments due to the recipient. At various stages of the application process, the software layer 833.1 may make calls to the customization layer 833.2. The customization layer 833.2 may provide specific algorithms for calculation of entitlements and payments including net calculations according to local rules. The instructions in the software layer 833.1 may cause a processor to implement functions stored within the customization layer 833.2, such as customizable rule sets for calculating gross entitlements, gross payments and net calculations according to the SSP, EID and PID.

The customization layer 833.2 may be developed and maintained by the end user. This allows the end user to modify any rules sets as changes occur in the criteria related to the calculation and payment of the social services. In addition, as new services are provided, the end user may generate new, or updated, rule sets that are called by the software layer 833.1. The social services agency, or end user, that is accepting, processing according to the described exemplary methods, and/or approving the applications, social services plans, entitlement items documents and payment items documents may use rule engines, as known in the computer science field and provided by vendors such as SAP® and the like, to customize the rule sets in the customization layer 833.2. Alternatively to using a rules engine, the customized rule sets in customization layer 833.2 may be formulated and generated by hard coding, or developed in some other manner.

When the social services plan is completed and approved for the requestor/recipient 805, electronic documents incorporating data items may be generated to provide the details of the services that comprise the social services plan for the requestor/recipient 805. The data items within the social services plan may be used by the CRM application executing on the front end 830 to generate an entitlement items document. The entitlement items document may comprise current data items indicating the type of benefits to be provided, dates on which the benefits are due to be provided, and the amount of benefits the recipient is entitled.

The exemplary method and computer program instructions may be embodied on a machine readable storage medium such as a computer disc, optically-readable media, magnetic media, hard drives, RAID storage device, and flash memory. In addition, a server or database server may include machine readable media configured to store machine executable program instructions. The features of the disclosed embodiments may be implemented in hardware, software, firmware, or a combination thereof and utilized in systems, subsystems, components or subcomponents thereof. When implemented in software, the elements of the disclosed embodiments are programs or the code segments used to perform the necessary tasks. The program or code segments can be stored on machine readable storage media. The “machine readable storage media” may include any medium that can store information. Examples of a machine readable storage medium include electronic circuits, semiconductor memory device, ROM, flash memory, erasable ROM (EROM), floppy diskette, CD-ROM, optical disk, hard disk, fiber optic medium, or any electromagnetic or optical storage device. The code segments may be downloaded via computer networks such as Internet, Intranet, etc.

Although the disclosed embodiments have been described above with reference to specific embodiments, the above embodiments and the specific configurations shown in the drawings are not limiting. For example, some components shown may be combined with each other as one embodiment, or a component may be divided into several subcomponents, or any other known or available component may be added. The operation processes are also not limited to those shown in the examples. For example, instead of being directed to a social service plan as described in the embodiments, services such as scheduled bank payments, or pension plan payments, may also utilize the features described in the specification. Those skilled in the art will appreciate that the disclosed embodiments may be implemented in other ways without departing from the spirit and substantive features of the invention. For example, features and embodiments described above may be combined with and without each other. The present embodiments are therefore to be considered in all respects as illustrative and not restrictive. The scope of the disclosed embodiments is indicated by the appended claims rather than by the foregoing description, and all changes that come within the meaning and range of equivalency of the claims are therefore intended to be embraced therein.

What is claimed is:

1. A computer-implemented method for confirming and updating the type and amount of service benefits provided to a recipient, comprising:
obtaining, at a back end of a computer system, data of a services plan generated at a front end of the computer system, wherein the social services plan includes data items indicating the type of benefits to be provided, dates for providing the benefits, and determination dates of the benefits;
generating, at the back end of the computer system, according to the obtained data of the services plan, a current entitlement item document containing current data items indicating the type of benefits to be provided, dates on which the benefits are due to be provided, and the amount of benefits the recipient is entitled;
generating, at the back end of the computer system, according to the current entitlement item document, a current payment item document containing data items indicating the type of benefits, the amount of services benefits to provide to the recipient, and the frequency of payment of the benefit; and
triggering payments to the benefit recipients based on service amounts in the generated payment document.

2. The method of claim 1, wherein the generating a current entitlement item document comprises:
obtaining previously generated entitlement item documents;
identifying data item due dates in the previously-generated entitlement item documents that are different from due dates of similar data items in the current entitlement item document;
processing any data items having due dates identified as future due dates according to a rule set related to data items having future due dates;
processing any data items having due dates identified as past due dates according to a rule set related to data items having past due dates; and
generating the current entitlement document based on results of the processing of data items having future and past due dates.

3. The method of claim 2, wherein the processing of data items having due dates identified as past due dates according to a rule set related to past due dates comprises:
obtaining data items having due dates that overlap from a previously-generated entitlement item document to the current entitlement item document;
calculating differences between old entitlement amounts corresponding to the data items from a previously-generated entitlement item document and new entitlement amounts corresponding to the entitlement data items to be incorporated into the current entitlement item document;
setting status of entitlement data item based on the due date; and
generating a payment data item based on the status setting.

4. The method of claim 3, wherein the generating a payment item based on status comprises:
retrieving the status of entitlement item the status;
creating a new payment item with a difference amount having new due dates when the retrieved status is an active status; and
creating a new payment item for use in a follow-up process when the retrieved status is an on-hold status.

5. The method of claim 4, wherein the generated payment item may indicate a reduction in the amount of services provided to a recipient.

6. The method of claim 2, wherein the processing of data items having due dates identified as future due dates according to a rule set related to future due dates comprises:
obtaining items that overlap from a previously-generated entitlement document to the current entitlement document;
flagging overlapping items as delimited by current item; and
generating a new payment item.

7. The method of claim 1, further comprising:
retrieving the current payment item document;
retrieving other existing gross payment item documents containing data items to be processed together;
build sub periods for net calculation;
upon building all sub periods for the net calculation, create a net calculation document including payment data items tax items and deduction items per each sub period;
determine if any previous net calculation documents need to be delimited; and
generating a final net calculation documents.

8. A computer system for providing services, comprising:
a front end of the computer system interfacing with a plurality of client computers; and
a back end server connected to the plurality of client computers, the server including a processor and a connection to a database, the processor configured to execute computer program instructions of:
obtaining data of a services plan generated at the front end of the computer system, wherein the services plan includes data items indicating the type of benefits to be provided, dates for providing the benefits, and determination dates of the benefits;
generate according to the obtained data of the services plan, a current entitlement item document indicating the type of benefits, dates for providing the benefits, and the amount of services benefits to provide to the recipient;
generate, according to the current entitlement item document, a payment item document indicating the type of, the amount of services benefits to provide to the recipient, and the frequency of payment of the services benefit; and
triggering payments to the benefit recipients based on service benefit amounts in the generated payment document and the amounts indicated in the payment document.

9. The computer system of claim 8, wherein the back end server is further configured to:
obtain previously generated entitlement documents;
identify data item due dates in the previously-generated entitlement documents that are different from due dates of similar data items the current entitlement document;
process any data items having due dates identified as future due dates according to a rule set related to data items having future due dates;
process any data items having due dates identified as past due dates according to a rule set related to data items having past due dates; and
generate the current entitlement document based on results of the processing of data items having future and past due dates.

10. The computer system of claim 9, wherein the back end server is configured to process data items having due dates identified as past due dates according to a rule set related to past due dates by:
obtaining data items having due dates that overlap from a previously-generated entitlement document to the current entitlement document;
calculating differences between old entitlement amounts corresponding to the data items from a previously-generated entitlement document and new entitlement amounts corresponding to the data items to be incorporated into the current entitlement document;
setting status of entitlement item based on the due date; and
generating a payment item based on status.

11. The computer system of claim 10, wherein the back end server is configured to generate a payment item based on status by:
retrieving the status of entitlement item the status;
creating a new payment item with a difference amount having new due dates when the retrieved status is an active status; and
creating a new payment item for use in a follow-up process d when the retrieved status is an on-hold status.

12. The computer system of claim 9, wherein the back end server is configured to process data items having due dates identified as future due dates according to a rule set related to future due dates by:
obtaining items that overlap from a previously-generated entitlement document to the current entitlement document;
flagging overlapping items as delimited by current item; and
generating a new payment item.

13. A machine-readable storage medium embodied with program instructions for causing a computer to execute a method for providing services, the method comprising:
obtaining, at a back end of a computer system, data of a services plan generated at a front end of the computer system, wherein the services plan includes data items indicating the type of benefits to be provided, dates for providing the benefits, and determination dates of the benefits;
generating at the back end of the computer system, according to the obtained data of the services plan, a current entitlement document containing current data items indicating the type of benefits to be provided, dates on which the benefits are due to be provided, and the amount of benefits the recipient is entitled;
generating, according to the current entitlement document, a payment document containing data items indicating the type of benefits, the amount of services benefits to provide to the recipient, and the frequency of payment of the benefit; and
triggering payments to the benefit recipients based on the generation of the payment document and the amounts indicated in the payment document.

14. The machine-readable storage medium of claim 13, wherein the generating a current entitlement document comprises:
obtaining previously generated entitlement documents;
identifying data item due dates in the previously-generated entitlement documents that are different from due dates of similar data items the current entitlement document;
processing any data items having due dates identified as future due dates according to a rule set related to data items having future due dates;
processing any data items having due dates identified as past due dates according to a rule set related to data items having past due dates; and
generating the current entitlement document based on results of the processing of data items having future and past due dates.

15. The machine-readable storage medium of claim 14, wherein the processing of data items having due dates identified as past due dates according to a rule set related to past due dates comprises:
obtaining items that overlap from a previously-generated entitlement document to the current entitlement document;
calculating differences between old entitlement amounts from previously-generated document and new entitlement amounts in current entitlement document;
setting status of entitlement item based on the due date; and
generating a payment item based on status.

16. The machine-readable storage medium of claim 15, wherein the generating a payment item based on status comprises:
retrieving the status of entitlement item the status;
creating a new payment item with a difference amount having new due dates when the retrieved status is an active status; and
creating a new payment item for use in a follow-up process d when the retrieved status is an on-hold status.

17. The machine-readable storage medium of claim 14, wherein the processing of data items having due dates identified as future due dates according to a rule set related to future due dates comprises:
obtaining items that overlap from a previously-generated entitlement document to the current entitlement document;
flagging overlapping items as delimited by current item; and
generating a new payment item.
